(19) United States
(12) Patent Application Publication
(10) Pub. No.: US 2016/0170394 A1
(43) Pub. Date: Jun. 16, 2016

(54) Transfer apparatus for a measuring instrument and method for transferring raw data using a transfer apparatus

(71) Applicant: VEGA Grieshaber KG, Wolfach (DE)

(72) Inventors: Volker ALLGAIER, HASLCH i.K. (DE); Holger STAIGER, HARDT (DE)

(21) Appl. No.: 14/902,800

(22) PCT Filed: Jul. 3, 2014
(86) PCT No.: PCT/EP2014/064265

§ 371 Date: Jan. 4, 2016

(30) Foreign Application Priority Data
Jul. 3, 2013 (DE) 10 2013 213 040.6

(51) Int. Cl. G05B 19/042; H04L 29/08; G01F 23/00

(52) U.S. Cl. CPC G05B 19/0423; G01F 23/0061; H04L 67/12; G05B 2219/21063

(57) ABSTRACT

A transfer device for a measurement device includes a raw data interface for direct access to the raw measurement data of the measurement device; an identification device identifying the raw measurement data with a measurement device identifier; and a transmission device transmitting the raw data that have been identified to an external evaluation device. The external evaluation device is arranged externally to the measurement device and/or externally to the transmission device, and the measurement device identifier allows the external evaluation device to associate the raw measurement data with the measurement device and/or the transmission device, said raw measurement data being transmitted substantially unchanged.

### TECHNICAL FIELD OF THE INVENTION

The invention relates to measurement technology. In particular, the invention relates to a transfer apparatus for a measuring instrument, to a method for transferring raw measurement data using a transfer apparatus, to an evaluation apparatus, to a measurement system and to a program element for transferring raw measurement data.

### BACKGROUND OF THE INVENTION

Conventional commercial sensor systems in the field of level measurement technology calculate measurement results directly on site, in other words in the measuring instrument itself. To calculate these target measurement values, in other words the measurement results that are actually of interest, a small microcontroller system having a limited energy requirement and having limited computation capabilities is often provided in the measuring instrument. Since, in measurement systems which operate using radar technologies or other radio technologies, detecting the target measurement values is generally linked to detecting what is known as an echo curve, and this echo curve may comprise many data points or sampling points which are discrete in value and in time, a high computing complexity may often be required for the calculation. A high computing complexity may occur because the echo curves have to be processed using correspondingly complex algorithms so as to achieve the target measurement values. This high computing complexity leads to a limited number of calculations per second and to a very static behaviour of the measuring instrument, a fact that particularly applies to application cases having particular features in the echo curve. In this context, corresponding parameterisation is often used on site, in other words setting or adjustment of parameters is used, to make the measuring instrument able to operate appropriately in the existing situation.

US 2011/0268273 describes a data processing apparatus for a field instrument in which calculated measurement results which are actually of interest are passed on encrypted.

The essay “Processing of gas-chromatography data by means of modern electronic integrators in connection with small calculating systems”, by Bischet, G. and Knechtel, G., from Chromatographia 1972, Volume 5, Issue 2-3, pages 166-172, describes an integrator-minicomputer system INFOCALC W which performs the identification of individual components and provides a complete analysis protocol in plain text.

### SUMMARY OF THE INVENTION

There may be a need to make more efficient evaluation of measurement values possible.

Accordingly, a transfer apparatus, a method for transferring raw measurement data, an evaluation apparatus, a measurement system and a program element are provided.

One aspect of the invention is set out in the independent claims. Developments of the invention are set out in the dependent claims.

One aspect of the present invention describes a transfer apparatus for a measuring instrument. The transfer apparatus comprises a raw data interface or raw measurement data interface for direct access to raw measurement data of the measuring instrument and a labelling device for labelling the raw measurement data with a measuring instrument label. Further, the transfer apparatus comprises a transmission device for transmitting the labelled raw data or raw measurement data to an external evaluation apparatus, the external evaluation apparatus being arranged externally to the measuring instrument and/or externally to the transmission device. The measuring instrument label makes it possible for the external evaluation apparatus to assign the raw measurement data to the measuring instrument and/or to the transfer apparatus which generated and transferred them. The raw measurement data are transmitted substantially unchanged. Therefore, the raw measurement data are transmitted as they are received at the raw data interface. Transmitting the raw measurement data can reduce the computing complexity on site and lead to a reduction in the energy requirement in the measuring instrument.

Labelling the raw measurement data may make it possible for the evaluation apparatus to send externally calculated measurement values back to the transfer apparatus again, and in particular to the measuring instrument. For receiving, in one example, the transfer apparatus may comprise a label recognition device or an address evaluation device which is set up to detect a measuring instrument label assigned to it in the received data and to process further or to display the data received having this measuring instrument label. The measuring identification label for the received data which are sent back by the external evaluation apparatus may be the same label with which the data were transmitted, for example a sending address, or another label, for example a receiving address.

A further aspect of the present invention provides a transfer apparatus for a measuring instrument, comprising a raw data interface for direct access to the raw measurement data of the measuring instrument, a labelling device for labelling the raw measurement data with a measuring instrument label, and a transmission device for transmitting the labelled raw measurement data to an external evaluation apparatus. The external evaluation apparatus is arranged externally to the measuring instrument and/or externally to the transmission device, and the measuring instrument label makes it possible for the external evaluation apparatus to assign the raw measurement data to the measuring instrument and/or to the transfer apparatus, in other words to detect that the raw data originate from a particular measuring instrument and/or from a particular transfer apparatus. The raw measurement data are transmitted unchanged, and the raw data interface is adapted to bypass an evaluation apparatus present in the measuring instrument. In one example, an internal evaluation apparatus provided in the measuring instrument or in the field instrument and/or an internal calculation device may be bypassed or disabled as soon as the transfer apparatus is connected to the measuring instrument.

In other words, the raw data interface or the raw measurement data interface of the transfer apparatus may be formed in such a way that it bypasses or switches off a calculation device which may be present in the measuring instrument, in such a way that the raw measurement data are not processed further within the measuring instrument, but instead are passed on unchanged to the transfer apparatus, in other words substantially as they were received by the measuring instrument itself, for example by a sensor. To make it possible for the measuring instrument to detect that a transfer apparatus is connected thereto, the raw data interface of the transfer apparatus may comprise a plug having a pin coding which can be detected by a measuring instrument equipped with a correspondingly pin-coded socket. The raw measurement data interface of the transfer apparatus may for example be coupled to a raw measurement data interface of the measuring instrument. Alternatively, the raw measurement data interface may, upon connection to the raw measurement data interface of the measuring instrument, actuate a switch which triggers a signal which signals to the measuring instrument not to use a potentially present calculation device or internal evaluation apparatus, by switching it off and passing on the raw measurement data directly to the transfer apparatus.

A further aspect of the present invention describes a method for transferring raw measurement data by means of a transfer apparatus. The method comprises the method step of accessing the raw measurement data of a measuring instrument by way of direct access. Further, the method comprises labelling the raw measurement data with a measuring instrument label and transmitting the labelled raw measurement data to an external evaluation apparatus. The external evaluation apparatus is arranged externally to the measuring instrument or externally to the transmission device. Moreover, the measuring instrument label makes it possible for the external evaluation apparatus to assign the raw measurement data to the measuring instrument or transmission device which generated them. The raw measurement data are transmitted substantially unchanged. Transmitting the raw measurement data unchanged may mean that the raw measurement data are transmitted substantially as they were provided by the measuring instrument or as the measuring instrument itself received them, resulting in simulating direct access to the raw measurement data for a receiver of the raw measurement data. Merely measures required for the transfer, such as provision with a transfer header or breaking down the raw measurement data into small, transferable packets, may be carried out.

Changes relating to the raw measurement data, such as changes to the format of the raw measurement data or changes to the order of the raw measurement data, substantially may not be carried out when doing so, and so the raw measurement data are maintained as they were received by the measuring instrument or sensor. In one example, not only the raw measurement data, in particular the measurement values, may be transmitted unchanged, but also or in addition indices may be passed on unchanged, which are used for example to assign the raw measurement data either to an operator or to an end client. In another example, indices are also passed on unchanged which are used to check the order of the raw measurement data. Therefore, all of the data, raw measurement data, sorting parameters or indices will be maintained as they were received by the measuring instrument or sensor. Changes to the raw measurement data may substantially only take place outside the measuring instrument. In particular, no further evaluation, calculation or processing of the raw measurement data may take place within the transfer apparatus, such as determining a fill level or a target measurement value. The method may also comprise receiving a calculated measurement value and providing this calculated measurement value. This calculated measurement value may have been calculated by the external evaluation apparatus.

In conclusion, the invention may provide transferring raw data or raw measurement data, in particular raw sensor data or physical measurement values, to a central computation system, where the further processing and evaluation of the raw data take place, via a communication network by means of a transmission device.

In one example, access to the raw data may take place via an interface at which the raw measurement data, in particular an echo curve, can be read out. Since the raw data are basically physical measurement values, the raw measurement data may be captured at a hardware interface. In one example, an interface via which the raw data or raw measurement data can be provided may be at least one interface which is selected from a group of interfaces, the group consisting of a parallel interface, a serial interface, a wireless interface, a wired interface and a radio interface. Examples of a serial interface are an RS232 interface, a USB interface, a Modbus/RS485 interface, an I²C interface or an SPI (serial peripheral interface). Examples of parallel interfaces comprise an 8-bit parallel port, a 16-bit parallel port, a 32-bit parallel port or a 64-bit parallel port. A radio interface may be in the form of a WLAN (wireless local area network), a Bluetooth interface, a ZigBee interface, an ANT+ interface or another interface which uses the ISM band (industrial, scientific and medical band).

The terms “raw data” and “raw measurement data” may be understood as equivalent and denote substantially unchanged data.

A further aspect of the present invention provides an evaluation apparatus which comprises a receiving device for receiving raw measurement data labelled with a measuring instrument label. The evaluation apparatus may receive the raw measurement data from a transfer apparatus. The evaluation apparatus further comprises a management device for managing at least one measuring instrument, an assignment device for assigning the received raw measurement data to one of the at least one managed measuring instruments. In addition, the evaluation apparatus comprises a calculation device for calculating a measurement value from the raw data or a processing device for processing the raw measurement data. This calculated measurement value may be the measurement value of interest or the target measurement value. By means of a provision device, the evaluation apparatus can provide the calculated measurement value or the target measurement value, for example on a display or to a transfer device.

A further aspect of the present invention describes a measurement system which comprises a measuring instrument, a transfer apparatus according to the invention, a communication network and an evaluation apparatus according to the invention. The measuring instrument is connected to the transfer apparatus via a data interface in such a way that the transfer apparatus can directly access the raw measurement data of the measuring instrument, which are generated by the measuring instrument or sensor. The evaluation apparatus is connected to the measuring instrument and/or to the transfer apparatus externally to the measuring instrument and/or externally to the transfer apparatus by means of a communication network. The communication network may be used for transmitting the measurement data. Likewise, calculated data may be sent over the communication network. The transfer apparatus is connected to the communication network by means of a transmission device, in such a way that the transfer apparatus can transmit the raw measurement data to the evaluation apparatus substantially unchanged via the communication network.

A further aspect of the present invention describes a program element for transmitting measurement data which carries out the method according to the invention when executed by a processor.

A further aspect of the present invention provides a computer-readable storage medium which contains a program code which carries out the method according to the invention for transferring raw measurement data when executed on a processor.

A computer-readable storage medium may be a floppy disk or hard drive, a USB (universal serial bus) storage medium, a RAM (random-access memory), a ROM (read-only memory), an EPROM (erasable programmable read-only memory), an EEPROM (electronic erasable programmable read-only memory), a flash memory or a FRAM (ferromagnetic random-access memory). However, a computer-readable storage medium may also be a data network, for example the Internet, which makes it possible to download a program code. Further, both the program element and the program code may be in the form of a software patch.

I²C, I2C or IIC (inter-integrated circuit) may be a serial bus for computer systems. It may be used to connect devices having a low transfer speed to an embedded system or a main circuit board. However, the I2C interface may also be used for access to raw data. The I2C interface is a hardware interface.

The HART® protocol (highway-addressable remote transducer) may in particular refer to an open master-slave protocol for bus-addressable field instruments. It can implement a method for transferring data by frequency shift keying (FSK), based on the 4 to 20 mA process signal, so as to make remote configuration and diagnosis testing possible. The HART® protocol or a HART® interface can also be used to transfer raw data. The 4 to 20 mA interface or the HART® interface is a hardware interface, the 4 to 20 mA interface being an analogue interface which, by using the HART® protocol and the physical components or hardware thereof, is made able to transfer digital data.

Both I2C and HART® may be suitable as a protocol for communication with a field instrument or measuring instrument, for example with an evaluation instrument, with a level measuring instrument or with a pressure measuring instrument.

A measuring instrument or field instrument within the meaning of the present application may for example be a level measuring instrument, a limit measuring instrument, a pressure measuring instrument, a flow measuring instrument, a pulse measuring instrument, a frequency measuring instrument or a temperature measuring apparatus. Various physical effects may be exploited to capture the raw data. For capturing the measurement values c radar beams, ultrasound, vibration, a guided microwave (TDR, time domain reflection), radioactive radiation or capacitive effects can be used. By means of this measurement value capture, the raw data or an echo curve, in particular the raw data of an echo curve, are detected. The measurement values can be accessed substantially directly at the measuring instrument or sensor. For accessing, the measuring instrument may comprise a raw data interface. Raw data may be present in various formats, but generally do not have directly measurable physical variables or units, like a voltage, a temperature, a level, a number or a capacitance. In one example, raw measurement data may be an ordered table or list in which an order of the raw data is specified by an ordering parameter. An ordered list of this type may comprise a progression or a curve and a number of values. An ordered list may be a list of any desired dimension, for example a two-dimensional or a three-dimensional list, it being possible for the dimension of a list of this type to be determined by way of the number of columns. An example of an ordered list in which the time at which the measurement takes place is used as the ordering parameter may be a progression of a voltage (in V) over time, a progression of a level (in dB, dBm or dBμV) over time, a progression of a length over time (in m) or the progression of a pulse over time. In a progression of this type of a physical variable, a physical measurement value at a point in time may be assigned to this corresponding point in time. Another example of an ordering parameter may be the temperature, for example in a progression of a capacitance (in F) against a temperature (in ° C.).

Raw data may for example originate from an electronic hardware such as an IC or an A-D converter, which converts physical variables into digital values, which are for example also in a temporal relationship, and makes them available at an interface. These values are subsequently received by a calculation unit or an internal evaluation apparatus. The calculation unit should convert these data into a usable measurement value or target measurement value, such as a fill level, which can subsequently be represented in for example 1, 2 or 4 bytes. In other words, a data volume representing the raw data may differ from the data volume representing the target measurement values. The raw data may be combined into a target measurement value. Therefore, the data volume of the raw data may be greater than the data volume of the target measurement value. For example, the data volume of raw data associated with one target measurement value, such as the fill level, may be represented as an array or a plurality of bytes, whilst the target measurement value may have a smaller plurality of bytes. In one example, the raw data may be representable as 32-byte words, whilst the target measurement value has 4 bytes. A raw measurement value, for example an echo curve, may have a larger storage requirement than the target measurement value.

In another example, the raw data, which may originate from for example 1000 measurements and can be combined in a list, may be captured and transferred by a transfer apparatus, substantially without using an internal evaluation apparatus. These data thus contain information which is discrete in time and/or discrete in value, and are not evaluated or combined to form a single piece of measurement information in the measuring instrument, but are first conveyed by the transfer unit to a central computation system or to an external evaluation apparatus.

One example of a form in which physical measurement values are provided if a reflection method is used is an echo curve. An echo curve is a progression of a voltage over time, the voltage being generated by a received pulse.

An echo curve may for example consist of several hundred bytes, from which it is virtually impossible to draw conclusions as to the desired measurement value or target measurement value without obligatory deeper insights, for example insights from processing or calculation. The target measurement value can only be derived by preparing or processing the echo curve, for example using the evaluation apparatus. A user can easily derive a state of a system, for example a fill level, from the target measurement value, but it is not readily derivable from the raw data. The target measurement value may be a compression or agglomeration of a plurality of raw measurement values, and thus be easier to handle than the raw data. For example, the storage region, the register size or bus width required for processing raw data, may be greater than that required for the associated target measurement values. Reprocessing an echo curve to achieve a compressed target measurement value may comprise various operations, for example filtering, smoothing, linearisation, interference elimination etc.

The echo curve may comprise a plurality of bytes which are only of limited interest to a user. The final measurement value or target measurement value, which just has a few bytes, can be determined from an echo curve of this type by measurement value preparation, for example in an internal evaluation apparatus and/or in a sub-program of a measuring instrument operating system. The reduction of the plurality of bytes to a smaller plurality of a few bytes may be referred to as compressing or agglomerating the raw measurement values. A processed and compressed target measurement value of this type may be simple for a user to understand. Therefore, there is not only a reduction in the data volume, in other words an agglomeration, but also a simplification of the data.

The information content per bit may be higher for a target measurement value than for raw measurement data. Because of the large number thereof, raw data are very complex and therefore hard for a user to understand; because of the smaller data volume thereof, target measurement values are simple to understand. The target measurement value for a fill level may be a single value, whilst the raw data from which it is derived comprise a plurality of values. In other words, a plurality of raw data may map to a single target measurement value. However, this mapping may not be reversible, meaning that it is not possible to conclude the associated raw data from a target measurement value.

Raw data may also contain signs, which are often evaluated in a subsequent measurement value processing system or evaluation apparatus and are subsequently no longer present in the processed data.

Raw data may be capacitance values, frequencies or a number of pulses, which are converted into target variables or target measurement values, such as the fill level or the gradient of a curve, or else into information as to whether a maximum or minimum of a curve is present at a particular point, only in an evaluation apparatus set up specifically for this purpose.

The raw data of an echo curve may be made available directly at an output of an analogue-digital converter, in particular at the digital output of the analogue-digital converter, before the raw data are converted into another form of measurement data by a processor or a signal processing system, for example into an evaluated measurement value or target measurement value. For example, the raw data of an echo curve may be the sampling points of a discrete echo curve. In another example, raw data may also be provided in the form of a curve, table or graph. They may consist of one or more dimensions. A temporal sequence of raw data and/or echo curves may also be relevant for calculating target measurement data or target measurement values. Target measurement data or target measurement values are subsequently calculated from various relationships or relations within the raw data. These may for example be calculated on the basis of the sign, the gradient, the absolute level or one or more offsets. An echo curve can be displayed as a two-dimensional table, which has two columns, one column comprising a time value and the other column comprising a voltage value which was measured at the measuring instrument or sensor at a point in time corresponding to the time value.

In general, a measuring instrument or field instrument may refer to a combination of a sensor and a measurement value processing device, which are generally accommodated in a housing. However, since the measurement value processing according to the invention is executed in a place other than the place where the sensor is located, in this text a measuring instrument or a field instrument may also refer to a sensor alone. In particular, the sensor comprises a raw data interface at which raw measurement data or raw data are provided. The raw measurement data may be a digitised echo curve. The raw measurement data are characterised in that they are in a close relationship with the physical effect used for the measurement. However, to determine the target measurement value, it may be necessary to process the raw measurement data further using a digital data processing system. However, a digital processing system of this type may be arranged externally to the measuring instrument or sensor. In other words, raw measurement data may refer to the measurement values which can be generated by hardware, for example using physical sensors, FPGAs (field-programmable gate arrays) or analogue-digital converters.

Therefore the measuring instrument may manage substantially without signal processing. In a sensor, a processor may be provided substantially only for controlling a program sequence, and not for the further processing, calculation or preparation of data. Any calculations for which a processor is used and which convert the raw measurement data may run externally to the sensor.

To distinguish the raw data or raw measurement data from the measurement values which are actually of interest, the measurement values which are actually of interest may be referred to as target measurement values. For a level measurement by a transit time method or radar measurement method, transit times of reflections are physically detected by means of an echo curve. However, it is a fill level, which may be determined from the transit times or echo curves, that is actually of interest as a target measurement value. For this purpose, the raw measurement data or physical measurement values are converted into the associated target measurement value.

An evaluation apparatus, in particular an external evaluation apparatus, may be a control system or a central processor comprising corresponding evaluation algorithms. An evaluation algorithm may be implemented in a program element which is executed on a processor of the evaluation apparatus and which determines the measurement values which are actually of interest or target measurement values from the raw measurement data. The processor provided on the evaluation apparatus for processing the raw measurement data is a different processor from the processor optionally provided on the measuring instrument or sensor. The processor provided for processing the raw measurement data may be higher-performance or faster than the processor provided on the sensor. Also, the processor on the evaluation apparatus may have a higher energy consumption than the processor provided on the measuring instrument.

It is also possible for multiple or a plurality of echo curves which are supplied by a plurality of measuring instruments to be evaluated centrally on a single computing system, so as centrally to calculate the associated fill levels measured by the plurality of measuring instruments. It is also possible for a plurality of calculations, for example including calculations provided by various measuring instruments, to run in parallel or in multitasking operation on the processor of the evaluation apparatus. So as to transport the raw measurement data to the central computation system, the central server, the central evaluation apparatus or the central processing system, the Internet may be selected as a transportation medium. However, any other communication network may also be used which is accessible for example via a wireless connection. A wireless connection may be a UMTS (universal mobile telecommunications system) or an LTE network. For the adaptation to the transfer network, the transmission device of the transfer apparatus may be configured as a UMTS modem or as an LTE (long-term evolution) modern. As a result of the use of a UMTS modem, a substantially sufficient speed can be achieved for transferring a sufficient number of echo curves and thus for meeting the frequency at which echo curves are to be provided. The transfer may be carried out using a transfer device or a transmission device, which may be formed as a special adapter. An adapter of this type may for example comprise the UMTS modem. The transmission device may also be able to establish the connection to the central processor via the communication network and pass on the echo curves, which are received from the sensor via the raw data interface, to the central processor. The raw measurement data can be converted into the desired measurement values in the central processor using corresponding conversion algorithms, for example into a fill level or a limit, into a pressure or into a temperature. In other words, in the evaluation apparatus or in the central processor, a target measurement value of interest can be calculated by means of a signal processing device from the raw measurement data of the measuring instruments or sensors. Different specifiable or selectable algorithms for calculating the target measurement value may also be used in this context. For example, a method for determining the position of a maximum of the echo curve may be used to calculate a fill level.

Calculating a target measurement value, for example calculating a fill level from a single or a plurality of echo curves, at a central location outside or externally to the measuring instrument may be considered an aspect of the invention. A measuring instrument may provide the raw data of an echo curve at the raw data interface thereof.

The raw data of the echo curve may be detected on site, i.e. within the measuring instrument, by the measuring instrument, sensor or field instrument. However, the calculation of the value of the fill level from the raw data of an echo curve may take place on a different computation system, which is arranged spatially separated from the measuring instrument, for example separated by a communication network. Because of the spatial separation, different processors may be used for detecting the raw data and processing the raw data. The echo curve may also be referred to as an envelope curve. An echo curve may comprise a fixedly predetermined number of sampling values which are provided within a measurement cycle. An echo curve may for example be provided with a frequency of 10 echo curves per second. In one example, an echo curve can be created or provided with a frequency lying in a range of 1 to 20 curves per second, in other words even 18, 19 or 20 curves per second.

In another aspect of the present invention, the raw data interface is a measuring instrument interface selected from the group of measuring instrument interfaces, the group consisting of an I²C interface, a HART® interface and a 4 . . . 20 mA interface or a 4 to 20 mA interface.

In another aspect of the present invention, the raw data interface or the measuring instrument interface is set up to bypass an evaluation apparatus present in the measuring instrument.

An evaluation apparatus which is provided in a measuring instrument may detect the target measurement value on site. The direct connection of a transfer apparatus to the sensor may make the provided evaluation apparatus to be bypassed. As a result of a provided evaluation apparatus of this type being bypassed, the evaluation apparatus may be disabled and the transfer apparatus may pass on the raw data of a sensor to the external evaluation apparatus, without using the evaluation apparatus which is potentially provided in the measuring instrument. A measurement result generated by the evaluation apparatus provided locally in a measuring instrument, for example a fill level, can thus be ignored. It may therefore be possible to avoid an upgrade of a pre-existing field instrument without having to dispose of the sensor which generates the raw data. A development of evaluation algorithms on the central server can thus be used even for previously installed measuring instruments. In one example, bypassing can be achieved by means of a switch, which informs a processor of the measuring instrument to continue by providing just raw data at a specifiable interface after the switching. A switch of this type can also be switched by way of a command at the interface.

Bypassing an evaluation device may make it possible to retrofit a measuring instrument for use with the evaluation apparatus.

In another aspect of the present invention, the transfer apparatus for a measuring instrument, comprises a labelling device, which as well as labelling the raw measurement data also encrypts the raw measurement data.

In another aspect of the present invention, a transmission device comprises an interface which is selected from a group of transfer interfaces. The group of transfer interfaces consists of a wired interface, a radio interface and a wide-area network interface. A corresponding interface may comprise both the conversion of provided raw data into specific network protocols and the transfer of the data or the initiation of the transfer of the corresponding data. So as to adapt the raw data for transfer via the communication network, the transfer apparatus may carry out corresponding adaptation.

In another further aspect of the invention, the transfer apparatus is adapted to receive and provide a calculated measurement value.

Since an external data processing device, for example a central server, is used for calculating the target measurement value from the raw data, the target measurement value may be calculated externally to the measuring instrument. However, since the target measurement value, for example the fill level value, is often to be read on site at the measuring instrument itself, it may also be provided that the calculated measurement value or target measurement value is received by and also provided by the measuring instrument, in particular by the transfer apparatus. For the provision, a display device such as a display may be used.

In another further aspect of the present invention, the transfer apparatus is integratable into the measuring instrument.

After the integration, the transfer apparatus may form a unit together with the measuring instrument. For example, the transfer apparatus may be able to be screwed onto a measuring instrument, in such a way that the housing of a measuring instrument comprising a transfer apparatus is substantially indistinguishable from the housing of a measuring instrument without a transfer apparatus. Alternatively, the transfer apparatus may replace an existing superfluous evaluation device on an existing measuring instrument. The transfer apparatus may be positionable on the measuring instrument for example using a screw thread or bayonet connection. In one example, the measuring instrument may detect a screwed-on transfer apparatus and switch off the internal evaluation apparatus thereof if present. Alternatively or in addition, the transfer apparatus may perform the switch-off, for example by bypassing an internal evaluation apparatus of the measuring instrument.

In another further aspect of the present invention, the measurement value or target measurement value calculated by the evaluation apparatus may be a fill level, a pressure, a limit, a flow rate, a pressure difference or the frequency of a movement. The measurement of the frequency of a movement can be a target measurement variable in the state measurement of a rotational movement or of a shaft.

In another further aspect of the present invention, the calculation device of the evaluation apparatus is set up to evaluate an echo curve.

In another further aspect of the present invention, the provision device of the evaluation apparatus is set up to provide the calculated measurement value internally or externally.

The evaluation apparatus may comprise a display device on which the calculated measurement value or target measurement value can be displayed. Alternatively or in addition, however, the evaluation apparatus may also transfer the target measurement value to the measuring instrument, in such a way that the calculated measurement value or target measurement value can be displayed directly on the measuring instrument. As a result of the target measurement value being transferred, the target measurement value is available on site even though the calculation has taken place externally. To provide the target measurement value on another site, a transfer device may also be provided as a provision device.

It should be noted that different aspects of the invention have been described with reference to different subject matter. In particular, some aspects have been described with reference to device type claims, whilst other aspects have been described with reference to method type claims. However, a person skilled in the art can deduce from the above description and the following description that, unless described otherwise, in addition to any combination of features belonging to one category of subject matter any combination of features should be considered to be disclosed by the text as well, which relate to different categories of subject matter. In particular, even a combination of features of device type claims and features of method type claims is intended to be disclosed.

### BRIEF DESCRIPTION OF THE DRAWINGS

In the following, further exemplary embodiments of the present invention are described with reference to the drawings.

FIG. 1 shows a measurement system according to an exemplary embodiment of the present invention.

FIG. 2 shows a transfer apparatus according to an exemplary embodiment of the present invention.

FIG. 3 shows an evaluation apparatus according to an exemplary embodiment of the present invention.

FIG. 4 shows a flow chart for a method for transferring raw measurement data with a transfer apparatus according to an exemplary embodiment of the present invention.

FIG. 5 shows a block diagram of a connection of a measuring instrument comprising a transfer apparatus according to an exemplary embodiment of the present invention.

FIG. 6 shows a further block diagram of a connection of a measuring instrument to a transfer apparatus according to an exemplary embodiment of the present invention.

FIG. 7 shows a further block diagram of a connection of a measuring instrument to a transfer apparatus comprising a switch on a measuring instrument according to an exemplary embodiment of the present invention.

### DETAILED DESCRIPTION OF EMBODIMENTS

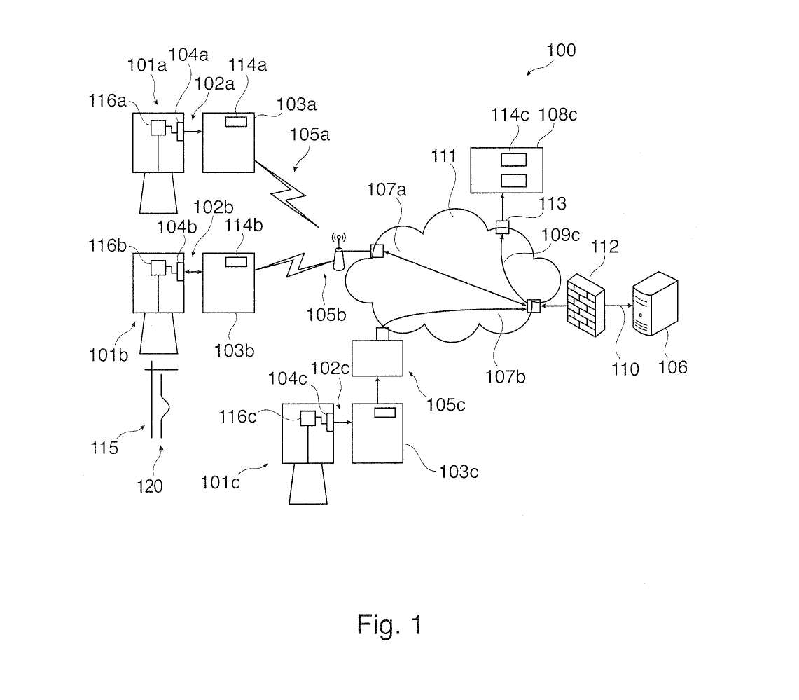

The drawings in the figures are schematic and not to scale. In the following description of FIG. 1 to 4, like reference numerals are used for like or corresponding elements.

FIG. 1 shows a measurement system 100 according to an example embodiment of the present invention. The measurement system 100 comprises three measuring instruments 101a, 101b, 101c. However, any desired number of measuring instruments may be used. In the present case, the measuring instruments 101, 101b, 101c are represented as sensors 101a, 101b, 101c, in other words as measuring instruments without an integrated evaluation device, without a processing device, without a calculation device or comprising a switched-off internal evaluation device. Via the raw data interfaces 102a, 102b, 102c, the transfer apparatuses 103a, 103b, 103c access the measuring instruments 101a, 101b, 101c. The raw data interface 102a, 102b, 102c of a transfer apparatus is directly connected to a raw data interface 104a, 104b, 104c of the measuring instruments. The transfer apparatuses 103a, 103b, 103c comprise the wireless transmission device 105a, 105b and the wired transmission device 105c in the transfer apparatus 103c. The transmission device can be configured as a transfer device. The first wireless transmission device 105a may for example be a UMTS transmission device, and the second wireless transmission device 105b may be an LTE transmission device. A mobile radio network 105a, 105b is conceivable as wireless transmission device. The wired transmission device 105c is in the form of a DSL (digital subscriber line) terminal. The transmission device 105a, 105b, 105c may be operated both unidirectionally and bidirectionally. In the embodiment of FIG. 1, both the UMTS interface 105a and the LTE interface 105b are formed as bidirectional interfaces. The raw data interface 102a and 102c is in the form of a unidirectional raw data interface, and the raw data interface 102b is in the form of a bidirectional raw data interface. The raw data which the transfer apparatus 103a, 103b, 103c receives via the raw data interfaces 102a and/or 102b of the measuring instrument 101a, 101b can be transferred to the central processor 106. Likewise, measurement values or target measurement values which have been calculated or processed by the central processor 106 can be transferred back to the transfer apparatus 103a, 103b. Accordingly, the network connection 107a is also formed as a bidirectional network connection 107a.

A bidirectional connection makes it possible for a transfer apparatus and in particular an associated measuring instrument not only to transmit raw data, but to receive processed data which are provided for example by an external evaluation apparatus. In the case of the bidirectional connection, it may be possible, by way of different sending and/or receiving addresses, IDs, in other words labels, or features such as a serial number or instrument name, or any desired combination of said features and properties, to detect which data are to be assigned to which system and how the required data preparation for the source system should look. Analysis, configuration, diagnosis or debug information may also be transmitted via a bidirectional interface of this type. The bidirectional interface and/or the bidirectional connection may be constantly open or else be closed during the calculation in the external evaluation apparatus. An open connection may refer to a connection which remains established after the connection to the external evaluation apparatus is established, while the evaluation apparatus carries out the calculation, in such a way that a return channel associated with this connection for the return transfer of the target measurement values can be used. A closed connection may describe either a scenario in which the transfer apparatus shuts down an established connection to the evaluation apparatus during the calculation, so as to establish it again to receive the calculated data, or a scenario in which the transfer apparatus establishes a connection for transferring the raw data to the evaluation apparatus, and shuts down this connection after the transfer, and the evaluation apparatus establishes a connection to the transfer apparatus after the calculation so as to transfer the calculated target measurement values. In the last scenario, the bidirectional connection can be implemented using associated unidirectional connections. The results of the calculation may be retrieved from the evaluation apparatus by the transfer apparatus after a time elapses in a timer, or the external evaluation apparatus may report to the transfer apparatus autonomously.

As a unidirectionally formed raw data interface, the raw data interface 102c merely makes transfer possible from the measuring instrument 101c to the transfer apparatus 103c and from there via the DSL terminal 105c and via the unidirectional connection 107b to the central processor 106. A measurement value or target measurement value calculated for the measuring instrument 101c is transferred to the control system 108c via the unidirectional measurement value connection 109c and displayed on the display 114c. No display of the target measurement value on the transfer apparatus 103c is provided. The central processor 106 comprises corresponding algorithms for calculating target measurement values from the received raw measurement data.

The central processor 106 is connected to the communication network 111 via the bidirectional network interface 110. The network connections 107a, 107b may be either connection-orientated connections, i.e. with previous connection establishment, or connectionless connections, i.e. packet-orientated connections. In a connectionless transfer, each sent data packet is provided using an individual address so as to reach the target thereof, for example to reach the evaluation apparatus 106. The evaluation apparatus 106 may be formed as a central server 106 and be loaded with a software or with a program code so as to process or evaluate the raw data. The evaluation method comprises receiving raw measurement data labelled with a measuring instrument label and managing at least one measuring instrument 101a, 101b, 101c. After the raw measurement data are received, the received raw measurement data are assigned to one of the at least one managed measuring instruments 101a, 101b, 101c. In a calculation device or in a processing device, a target measurement value is calculated from the received raw measurement data or raw data, and is passed on to a provision device 114a, 114b, 114c for the provision.

For security reasons, a firewall 112, which prevents undesired access to the evaluation apparatus 106 from the communication network 111, may be arranged between the network 111 and the evaluation apparatus 106. The network 111 may be any communication network 111, for example the Internet. The control system 108c may receive the target measurement values, which have been determined by the evaluation apparatus, via the network interface 113, which is likewise formed unidirectionally, and display them on a display 114c. The control system 108c may further comprise at least one display device 114c or a plurality of display devices 114c, which are each assigned to a measuring instrument 101a, 101b, 101c. Alternatively, the transfer apparatus 103a, 103b may also comprise a display device 114a, 114b or a display 114a, 114b, via which corresponding target measurement values determined by the central processor 106 can be displayed. As an alternative embodiment (not shown in FIG. 1), it is possible to arrange the display device 114a, 114b on the measuring instrument 101a, 101b or sensor 101a, 101b, so as to make it possible to display the target measurement value on site.

The display devices 114a, 114b are local display devices, which are arranged on site, in other words close to the measuring instruments, without a transfer network 111 being arranged between the display device 114a, 114b and the measuring instrument 101a, 101b. The display devices 114c are remote display devices, a transfer network 111 being arranged between the display devices, the transfer apparatuses 103a, 103b, 103c and/or the evaluation apparatus 106. A display device is therefore referred to as a remote display device 114c if there is a communication network 111 between the display device 114c and the measuring instrument 101c and/or the transfer apparatus 103c.

In FIG. 1, an envelope curve or echo curve 120 is shown schematically on the measuring instrument 101b in a graph 115, to show that a measuring instrument 101b is supplying the raw data. This echo curve 120 is for example generated in that a radar pulse is emitted by the measuring instrument 101b towards a filling material surface and the temporal progression of a received signal caused by this radar pulse is received and displayed by means of a high-frequency antenna (not shown in FIG. 1) contained in the measuring instrument 101b. The echo curve 120 displays a voltage progression over time. The received signal is present as a continuous echo curve in analogue form. In the analogue-digital converter 116a, 116b, 116c, the received HF pulses of the analogue echo curve 120 are converted into a digital display of the echo curve. The digital display of the echo curve comprises a plurality of sampling values at sampling points, and the progression of the digital echo curve substantially corresponds to the progression of the analogue echo curve. The sampling values of the digital echo curve (not shown in FIG. 1) are passed on to the raw data interfaces 104a, 104b, 104c of the measuring instruments 101a, 101b, 101c. At these raw data interfaces 104a, 104b, 104c of the measuring instruments, the raw data provided by the analogue-digital converters 116a, 116b, 116c, in particular the raw data of the echo curve 120, can be accessed directly by way of the raw data interfaces 102a, 102b, 102c of the transfer apparatuses 103a, 103b, 103c. The raw data are discrete voltage values over time.

When the raw data are accessed, a polling mechanism may be used. A polling mechanism may provide that, at a particular time interval, for example corresponding to the cycle duration of a measurement cycle for creating the echo curve 120, in each case the raw data 104a, 104b, 104c associated with a single echo curve are to be requested by the transfer apparatus 103a, 103b, 103c. As an alternative to a polling mechanism, a push mechanism may also be provided. In this case, after the raw data of a measurement of an echo curve are present at the raw data interfaces 104a, 104b, 104c, the measuring instrument 101a, 101b, 101c may actively pass the raw data on from the raw data interface 104a, 104b, 104c of the measuring instruments to the raw data interface 102a, 102b, 102c of the transfer apparatuses. For a mechanism of this type, the raw data interface may provide the presence of an echo curve or of raw data via a special signalling connection or signaling line.

Without substantially further processing, in particular without further processing by software, the raw data are passed on via the network interfaces 105a, 105b, 105c to the communication network 111 such as they were received from the analogue-digital converters 116a, 116b, 116c by the transfer apparatus 103a, 103b, 103c. The raw data are merely provided with information, such as a target address of the evaluation apparatus 106, which is necessary for transporting the raw data through the communication network 111, so as to reach the target, the evaluation apparatus 106, and the raw data are transmitted. For transmission, a radio connection 105a, 105b or a wired connection 105c may be used. The raw data to be transferred are transferred in the network 111 via the network connections 107a, 107b.

The raw data may also be furnished with further information or an ordering parameter, such as a date, a time value or time stamp, an index, a system name, an instrument operator, an instrument name or a software version.

An ordered list can be used to display raw data. By way of example, Table 1 shows a list of a time progression of a voltage such as is used for example in an echo curve. The list of Table 1 is a three-dimensional list having the three columns of time, measurement value or raw measurement value, and unit. The individual raw measurement values may have both positive and negative values.

TABLE 1

| Time in [ms] | Measurement value | Unit |
|---|---|---|
| . . . | . . . | . . . |
| 5 | 5 × 10⁻³ | V |
| 6 | 6 × 10⁻³ | V |
| 7 | −5 × 10⁻³ | V |
| 8 | −7 × 10⁻³ | V |
| . . . | . . . | . . . |

Because of the bidirectional nature of the connection 107a, raw data or echo curve data are transmitted via this connection as well as determined target measurement values being transmitted back to the transfer apparatus or the measuring instrument. Since the connection 107b is merely set up as a unidirectional connection, merely digital echo curve data or raw data are transferred to the evaluation apparatus 106 via this connection.

The evaluation apparatus 106 or the central processor 106 comprises a plurality of different calculation algorithms, among which selection is possible in one example. Likewise, the central processor 106 can be accessed so as to establish the evaluation algorithms by which the target measurement values are determined from the raw data. These evaluation algorithms can be exchanged. If a newer, more exact algorithm for the target measurement value calculation is found, it can thus merely be imported into the evaluation apparatus 106 and be used for the respectively associated measuring instruments. The calculated measurement values or target measurement values may be provided centrally either via a separate display 114c or via the control system 108c. For example, in this way a control room may also be supplied with a plurality of measurement values which were generated by the central processor 106 or by the evaluation apparatus 106. However, in addition or as an alternative to being displayed in a control room, the measurement values may also be transferred back directly to the transfer apparatuses 103a, 103b and/or to the measuring instruments 101a, 101b, so as to have the target measurement result or the target measurement value available at the respective site of the measurement. The transmission devices 105a, 105b, 105c may also provide encryption of the data. In the case of encryption, a complementary decryption function is provided on the central processor 106. The raw data may for example be in a proprietary file format or in an ordered list, as well as for example as a CSV (comma-separated values) file. The algorithms may be specified for the different filling materials or for specific mechanical arrangements.

As a result of the raw measurement data being transferred to a central server or a central processor 106, the algorithms for calculating the target measurement values from the raw data can be changed rapidly, for example in that an algorithm on the central processor 106 is merely replaced, for example by loading a patch or a new software library. Changing the software on the measuring instruments 101a, 101b, 101c can thus be avoided. As a result, the expenditure of time for maintenance can be reduced, and this in turn makes it possible to reduce the costs for updates. There is no software update or parameter change required on site, in other words in the measuring instruments themselves. It is thus sufficient merely to provide the sensors, including the HF technology and A-D converter 101a, 101b, 101c, 116a, 116b, 116c, and to output the data via the respective raw data interfaces 104a, 104b, 104c. No additional evaluation device which calculates the measurement values from the raw data is required, meaning that the measuring instruments 101a, 101b, 101c can be constructed smaller. Moreover, the measuring instruments 101a, 101b, 101c require less power or less energy than comparable measuring instruments having evaluation on site, since expenditure of power or energy for calculating the target measurement values can be prevented. Moreover, the raw data can be buffered on the central processor 106, meaning that the evaluation electronics on a measuring instrument and/or in the central processor 106 can also operate more slowly and thus be constructed with cheaper components than if a real-time evaluation had to take place on the measuring instruments.

As a result of the use of rapid broadband connections or Internet broadband connections, such as UMTS, LTE or DSL, sufficient amounts of data can be transferred. In other words, the data can be transported from the measuring instrument to the evaluation apparatus 106 at a very high frequency, meaning that very high measurement cycles for providing the echo curves 120 can be achieved. Thus, larger measurement cycles than 1 . . . 20 measurement cycles per second can be achieved. As a result of the rapid data relaying, without the raw data being processed, measurement cycles in the range of 1 to 50 measurement cycles per second or 21 to 50 measurement cycles can be achieved. The evaluation apparatus can have real-time capability.

Facilities or measurement systems 100 having particular arrangements can be set up by a manufacturer or operator of the measurement system 100, in particular by the manufacturer and/or the operator of the evaluation apparatus 106, by accessing the central processor 106 or the central evaluation apparatus 106. Likewise, parameterisation, in other words setting the parameters for the measuring instruments, can be performed on the evaluation apparatus 106, and it is not necessary to access each individual measuring instrument, in some cases at different locations and a long way apart, so as to perform the parameterisation. Examples of parameterisable properties are: detection thresholds, filter parameters, attenuation, tracking and interference echo suppression. Protracted software updates on site, in other words at the locations of the measuring instruments 101a, 101b, 101c a long way away from the evaluation apparatus 106, to which a measurement technician has to travel in some cases, can be carried out rapidly and for a plurality of measuring sites 101a, 101b, 101c on the central processor 106 by accessing the central processor. An operator of the central processor 106 can provide access for operators of the measuring instruments 101a, 101b, 101c, in such a way that in some cases an operator not in charge of the measurement technology, such as an agricultural operation or a chemical company, can evaluate measuring instruments, in particular level measuring instruments 101a, 101b, 101c, without itself having any understanding of the operation, the maintenance, and in particular the specific evaluation algorithms on the central processor 106.

Moreover, complex software algorithms, which often take a lot of work to develop, no longer have to be distributed in the field, in other words to each of the measuring instruments 101a, 101b, 101c a long way apart from one another, but can instead be kept on the central server by the manufacturer or operator. Because the algorithms are present at a central site, which can be specifically protected against foreign infiltration, for example by cyber criminals, using special protection mechanisms, such as a firewall 112, the risk of the algorithms being stolen or copied and the risk of the measurement data being copied can be reduced. The protected algorithms can no longer be read or manipulated by accessing the field instruments 101a, 101b, 101c, sensors 101a, 101b, 101c or measuring instruments 101a, 101b, 101c, which are often arranged a long way apart, since the evaluation algorithms are no longer installed there. Collection of the raw data and/or echo curves by the central server 106 may further make additional evaluation possible for testing, development, research and service purposes. It is thus possible to investigate and explore new application scenarios. The analysis of the quality of existing systems and of the algorithm used in the associated setup can be examined. Evaluation is also possible with storage of expired measurement values. An evaluation algorithm is used to generate target measurement values, such as the fill level, a gradient or a definition of minima or maxima, from physical raw data, such as voltage values. During the evaluation, a plurality of raw data can be combined to form a target measurement value.

Using a measurement system 100, it can be made possible to centralise the processing power on the server 106. As a result of this centralisation, the expense of setting a measurement site 101a, 101b, 101c in operation or maintaining or updating it can be reduced.

The digital echo curves are provided by the sensors 101a, 101b, 101c or by the measuring instruments 101a, 101b, 101c via raw data interfaces, for example via I²C, RS232 or USB. Via a correspondingly configured raw data interface 102a, 102b, 102c of the transfer apparatus 103a, 103b, 103c, these raw data, digital raw data or echo curves can be accessed. A connected microcontroller or processor establishes an Internet connection by way of a UMTS, LTE or DSL modem and transfers the read echo curves or raw data to the evaluation apparatus 106. The evaluation apparatus 106 substantially also comprises a raw data interface for receiving the raw data and a target measurement value interface for providing a target measurement value.

The evaluation apparatus 106 receives the transferred, unchanged raw data and assigns them to the corresponding measurement site 101a, 101b, 101c by means of an appended measuring instrument label. For the assignment, the evaluation apparatus 106 uses a label connected with the raw measurement data, for example header information in the transfer frame for the raw data, so as to make the raw data assignable. The raw data can be assigned to the corresponding measurements sites 101a, 101b, 101c before the target measurement values or fill level are determined from the echo curves or after the target measurement values are determined, wherein in the last case the target measurement values are assigned to the respective measurement sites 101a, 101b, 101c. The algorithms for calculating the target measurement values, in particular the fill level, from the echo curve are thus no longer present in the measuring instrument itself, but instead are maintained, overseen and if appropriate updated centrally.

The individual measurement sites 101a, 101b, 101c can be parameterised for example using a Web browser or Internet browser, by means of which the evaluation apparatus 106 is accessed. Different profiles, having different rights for merely querying measurement data and for parameterising measuring instruments, can also be set up on the evaluation apparatus 106.

In one embodiment, the measuring instrument 101a, 101b, 101c comprises the transfer apparatus 103a, 103b, 103c as an integrated apparatus, in such a way that the transfer apparatuses 103a, 103b, 103c are incorporated into the housing of the measuring instrument 101a, 101b, 101c. In a further embodiment, a pre-existing evaluation apparatus on a measuring instrument 101a, 101b, 101c can be replaced by the transfer apparatus 103a, 103b, 103c according to the invention, meaning that older measuring instruments of an older measuring instrument generation can be retrofitted for server-based evaluation.

For example, the transfer apparatus 103a, 103b, 103c may be configured in such a way that when attached to a measuring instrument it switches off an internal evaluation apparatus on the measuring instrument 101a, 101b, 101c. For this purpose, the measuring instrument may for example comprise a switch which switches off the internal evaluation apparatus when the transfer apparatus is connected to the raw measurement data interface. The A-D converter 116a, 116b, 116c in this way can be connected directly to the raw data interface 104a, 104b, 104c. Because of the direct connection, the bus width or bit width of the A-D converter may dictate the bus width of the raw data interfaces 102a, 102b, 102c, 104a, 104b, 104c.

The transfer apparatus 103a, 103b, 103c may also comprise a switch by means of which for example the display 114a, 114b can be switched on. Alternatively, the encryption can also be switched on by means of this switch or by means of an additional switch. In a development, a return channel of a bidirectional connection 105a, 105b can be established simultaneously with the display device 114a, 114b being switched on. The data can be encrypted by an AES (advanced encryption standard) algorithm or any other encryption method before the transfer via the communication network 111 takes place. In addition or alternatively, compression could take place, for example by a ZIP method.

By means of the label for the measuring instruments 101a, 101b, 101c, the measuring instruments can also be identified. It can thus for example be detected whether a measuring instrument which wishes to login to the server 106 is registered and cleared to use a particular calculation algorithm. Various quality classes for measuring instruments and algorithms may also be provided. For example, the use of a particularly high-quality algorithm for fill level measurement may be unlocked temporarily. It may also be possible to set up charging for the use of various evaluation algorithms, in such a way that it is also potentially possible to use a measuring instrument on a hire basis or an hourly basis. Further, a quality-based service may be provided, in which for example different sets of fees are provided for different categories of evaluation algorithms. It is further conceivable to implement the graphical preparation differently. Differentiated analysis of the calculated measurement values would thus also be possible, so as to use different analysis types in different applications. For example, it is possible to analyse the past or the changes at particular points in time. It is also possible to clear data for querying over a defined external interface, for example in the form of a Web service.

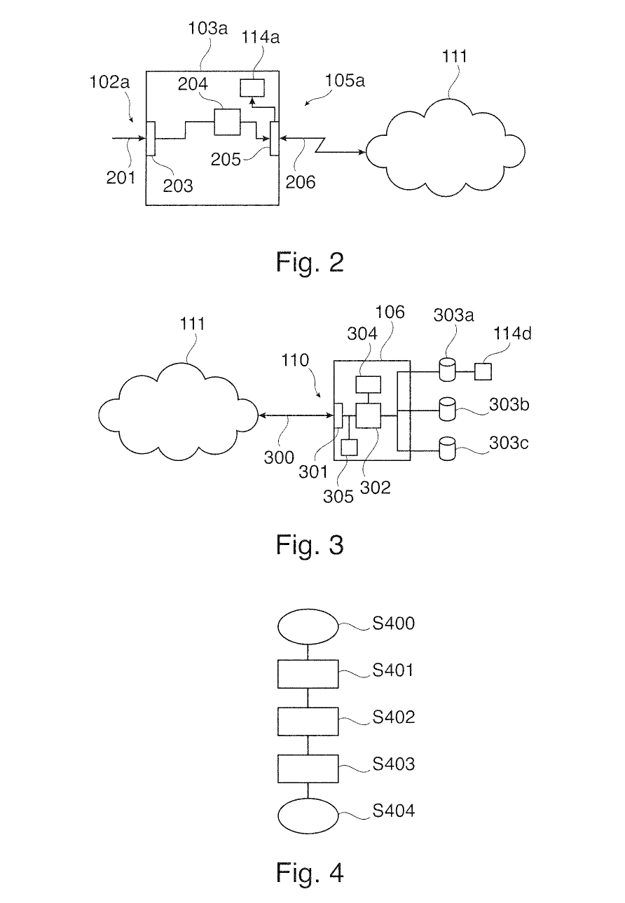

FIG. 2 shows a transfer apparatus 103a according to an exemplary embodiment of the present invention. The transfer apparatus 103a is also representative of the transfer apparatuses 103b and 103c. The transfer apparatus 103a comprises the raw data interface 102a. The raw data interface 102a can provide the connection line 201 which forms a physical raw data interface. The data interface 102a further comprises the protocol unit 203, which receives or queries the raw data but also provides the logical structure within the raw data. The raw data interface 203 passes on the received raw data to the labelling device 204, but does not change the raw data, and in particular does not carry out any processing of the raw data or any target measurement value calculation. The protocol unit 203 and/or the labelling device 204 merely carries out additional labelling of the raw data, which makes it possible for a remote evaluation apparatus 106 to assign the raw data to the transfer apparatus. Labelling of this type may be an Internet protocol address (IP address), a MAC (medium access control) address or any other form of label. The assignment can be made by way of information stored in the transfer apparatus 103a, 103b, 103c. The assignment can be made using a label established by the labelling device 204. The label may be selected from a group of labels which consists of the labels of serial number, IMEI (international mobile equipment identity), MAC address, measuring site ID, client ID, instrument driver ID, ICCID (integrated circuit card ID). In this context, ID refers to a label value or an identifier.

The labelled, unchanged data are subsequently passed on to the transmission device 105a. The transmission device 105a comprises the driver device 205, which cares about a logical adaptation to the communication network 111 of the data to be transferred. The transmission device 105a further comprises the network interface 206, which establishes the physical connection to the communication network 111. In the example of FIG. 2, the raw data interface 102a is formed as a unidirectional interface, in other words as a read interface for receiving raw data from a measuring instrument (not shown in FIG. 2). However, the raw data interface 102a may also be in the form of a bidirectional interface, for example for transferring display data to a measuring instrument (not shown in FIG. 2) for displaying.

In FIG. 2, a display device 114a is integrated into the transfer apparatus. Via the bidirectional network interface 105a, the labels and raw data can be transferred to an evaluation apparatus (not shown in FIG. 2). Target measurement values, determined from the raw data on a server, may also be received from the server. These target measurement values suitable for display can be passed on from the driver device 205 to the display device 114a for display.

FIG. 3 shows an evaluation apparatus 106 according to an exemplary embodiment of the present invention. The evaluation apparatus 106 comprises the receiving device 110, which is set up to receive raw measurement data labelled with a measuring instrument label. The receiving device comprises the network interface 300, which can establish a physical connection to a communication network 111. The driver device 301 provides a logical termination of a network protocol used between the evaluation apparatus 106 and the communication network 111. The management device 305, which makes it possible to manage at least one remote measuring instrument 101a, 101b, 101c, is further connected to the driver device 301. By means of the management device 305, for example a parameter for parameterising a measuring instrument can be stored. The evaluation apparatus 106 further comprises the assignment device 302, which serves to assign received measurement data to at least one of the managed measuring instruments 101a, 101b, 101c. For example, the assignment device 302 may perform assignment of the received raw measurement data for storage in different databases 303a, 303b, 303c or data stores 303a, 303b, 303c, each data store 303a, 303b, 303c being associated with one of the measuring instruments 101a, 101b, 101c. The raw data of the respective echo curves can be buffered on the data stores 303a, 303b, 303c. Calculated target measurement values may also be resaved or buffered in these databases 303a, 303b, 303c. It can thus be made possible for example to display the target measurement values, such as the fill level of one of the measuring instruments, on a display device 114d provided in the evaluation apparatus 106. Providing a target measurement value to a display 114a, 114b, 114c, 114d is an example of providing a target measurement value. In general, a provision device 114a, 114b, 114c, 114d is a device which serves to output the determined target measurement value. A provision device may also comprise a transfer device via which the target measurement value is transferred to a display.

The network interface 300, in particular the receiving device 110, may be made bidirectional, in such a way that the data do not have to be stored, or only have to be stored in part, in the databases 303a, 303b, 303c, and can instead be passed on to a control site (not shown in FIG. 3) or to a control system 108c for display. Further, the target measurement values may also be relayed back to the respectively associated measuring instruments 101a, 101b, 101c. The target measurement values may already comprise a display format suitable for the display. For relaying back to the measuring instruments or transfer apparatuses, the drive device 301 may also be set up to transmit target measurement values and provide corresponding target measurement values with a measuring instrument label.

The calculation device 304 or the processor 304 can calculate respective target measurement data or target measurement values from the received raw measurement data by means of algorithms. The input interface of the calculation device 304 can be referred to as a raw data interface, and the output interface as a target measurement value interface. Depending on the measuring instrument and the set algorithm, different algorithms may be used for each measuring instrument 101a, 101b, 101c individually in the calculation device 304. By way of an operating terminal (not shown in FIG. 3) or a user interface, an operator of the evaluation apparatus 106 or else a user of the evaluation device 106 can access the evaluation apparatus 106 and for example change parameters for the measuring instruments, set parameters (parameterisation) or even change the algorithms to be used or evaluate corresponding measurement values. It is also possible to set to which sites or to which display devices 114a, 114b, 114c, 114d the respective measurement values or fill levels are to be outputted.

FIG. 4 is a flow chart for a method for transferring raw measurement data by means of a transfer apparatus 101a, 101b, 101c according to an exemplary embodiment of the present invention. The method starts in an idle state S400. In step S401, raw measurement data of a measuring instrument 101a, 101b, 101c are accessed by means of the transfer apparatus. The access is direct, in other words without further processing of the raw measurement data after the digitisation by an analogue-digital converter. In step S402, the raw measurement data are labelled with a measuring instrument label. The measuring instrument label may for example be header information or an IP address of the respective measuring instrument 101a, 101b, 101c. Subsequently, in step S403, the labelled raw measurement data are transmitted to an external evaluation apparatus. A source address for a created data packet for measurement value transfer of the measurement data may also be used as a label.

The raw measurement data are transmitted to an external evaluation instrument or to an external evaluation apparatus 106, which is separated from the transfer apparatus at least by a communication network 111. By means of the measuring instrument label, an external evaluation apparatus 106 can assign the raw measurement data to the associated measuring instrument 101a, 101b, 101c or the transmission device 105a, 105b, 105c of a transfer apparatus 103a, 103b, 103c. When the output values or raw data of an analogue-digital converter 106a of a measuring instrument are transferred to the evaluation apparatus 106, substantially no change to the raw data may take place, and consequently an algorithm executed by a processor 204 on the evaluation apparatus can access the raw measurement data substantially directly, so as to determine a target measurement value, for example a fill level. An analogue-digital converter digitises the measurement value, but does not carry out any unit conversion, calibration, linearisation or scaling. The unit conversion is outsourced to the evaluation apparatus. The method ends at step S404.

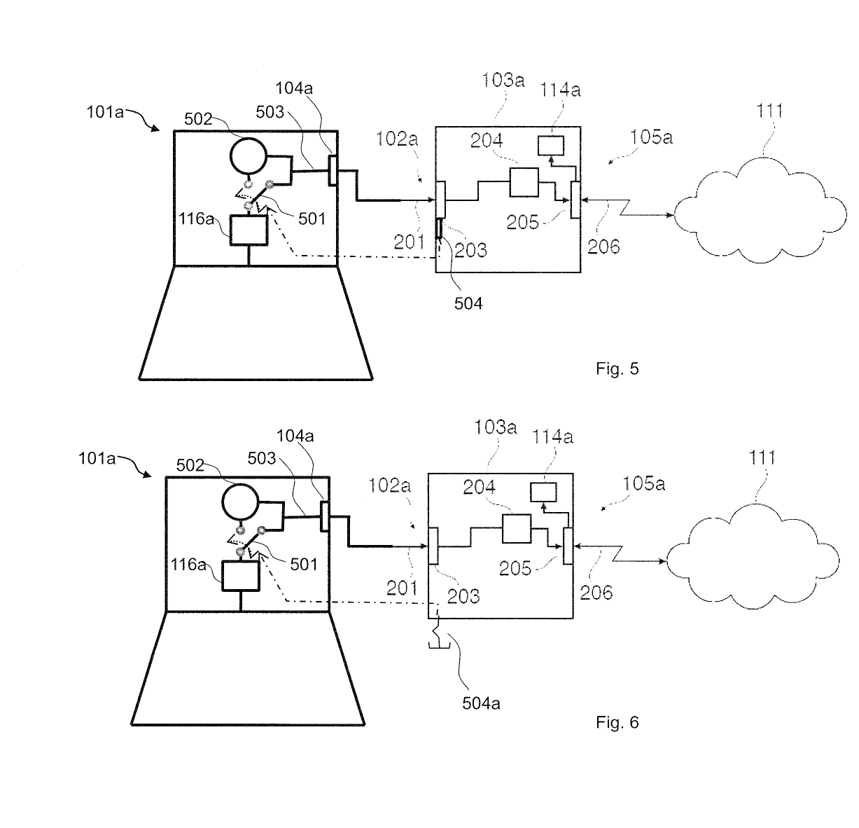

FIG. 5 is a block diagram of a connection of a measuring instrument 101a to a transfer apparatus 103a according to an exemplary embodiment of the present invention. The raw data interface 104a of the measuring instrument 101a is connected to the raw data interface 102a of the transfer apparatus 103a. The measuring instrument 101a shown in FIG. 5 is a measuring instrument which comprises an internal evaluation apparatus 502. The internal evaluation apparatus 502 may be a specific integrated circuit (IC) responsible for calculations, a specific processor which carries out the calculations, or a sub-routine of an operating system program of the measuring instrument 101a. The internal evaluation apparatus 502 may be used for calculating target measurement values from the raw data received for example at the A-D converter 116a. The internal evaluation apparatus 502 may process the raw data further. However, as can be seen from the situation shown in FIG. 5 of the connected state between the measuring instrument 101a and the transfer apparatus 103a, the pin coding 504 of the transfer apparatus 103a influences the bypassing device 501 in such a way that the raw data which leave the A-D converter 116a reach the raw data interface 104a directly, without going via the internal evaluation apparatus 502. Because of the direct connection, the bus width of the A-D converter may correspond to the bus width of the raw data interface 102a, 104a. Merely additional lines, for example control lines used for communication between the measuring instrument 101a and the transfer apparatus 103a, may additionally be present. However, the bus width of the data may be constant over the direct connections. The further processing of the raw data is performed by an external evaluation apparatus (not shown in FIG. 5), which is connected for example to the network 111. The raw data without control data or transfer data look exactly the same at the output of the A-D converter 116a as at the external evaluation apparatus.

Instead of or in addition to a pin coding 504, a socket/plug connection may be provided between the raw data interfaces 104a, 102a, which controls the bypassing device 501. The bypassing device 501 may be implemented as a switch, as an electronic switch, as a Y-member or as a jump command. The dashed line between the pin coding 504 and the bypassing device 501 represents the signal flow for controlling the bypassing. The use of a bypassing device may in particular be applied if pre-existing measuring instruments are used. The bypassing device 501 may also be implemented entirely on the transfer apparatus, in such a way that no constructional change has to be made to a field instrument 101a present in the field so as to use it with an external evaluation apparatus. The bypassing device 501 may be provided as a non-holding contact, which shorts out a provided internal evaluation apparatus.

In a measuring instrument constructed without an internal evaluation apparatus 502, the sensor interface or the A-D converter interface 116a is connected directly to the raw data interface 104a, in such a way that the raw data supplied by the sensor are passed on directly to the raw data interface 104a. For example, the raw data interface 104a may have the same bit width as the sensor output or the output of the A-D converter 116a. Since there also does not take place any processing between the raw data interfaces 104a, 102a, the bit width or bus width may not change here either.

FIG. 6 is a further block diagram of a connection of a measuring instrument 101a to a transfer apparatus 103a according to an exemplary embodiment of the present invention. In the transfer apparatus 103a shown in FIG. 6, a switch 504a or button 504a is provided which actuates the bypassing device 501. Alternatively, a magnet 504a may also be provided, which actuates a magnetic switch 501 on the measuring instrument 101a to carry out the bypassing. For this purpose, the measuring instrument 101a may comprise a reed contact and/or a Hall sensor. As a further alternative for actuating a bypassing device 501 by way of a transfer apparatus 103a, an LED (light-emitting diode) 504a may be provided which switches a photosensor 501.

In other words, the transfer apparatus 103a may comprise a bypassing apparatus 501, 504, 504a which bypasses an internal evaluation apparatus 502 of the field instrument, for example shorts out the input and output thereof. Alternatively, the transfer apparatus may comprise a selector switch 504a which is provided with the desired functionality, for example a rocker switch which has to be set to the desired position or functionality by the user. Alternatively, the bypassing can be actuated accordingly by way of bypassing device 501 by way of mechanical coding 504 on the transfer apparatus 103a. Further, this functionality can also be switched on and/or off by way of additional information in the transfer data flow of the data exchanged between the raw data interfaces 104a, 203. It is further possible to deactivate corresponding functions by way of a flexible sequence control system implemented in software and to operate the executing processing unit in power-saving standby modes for longer. Further, register entries or flags on the measuring instrument 101a, which switch the bypassing on and off by way of the bypassing device 501, may also be influenced by the transfer apparatus 103a. The signal for controlling the bypassing device 501, which is shown as a dashed line in FIG. 5 and FIG. 6, can be exchanged by way of the data flow between the raw data interfaces 104a, 102a. For transferring this signal, the raw data interface 104a, 102a may be realized as a bidirectional interface. As control mechanism for the bypassing device 501 may be provided by way of a switch 504a or button 504a for manual actuation. Further, the internal evaluation apparatus 502 may be made removable from the measuring instrument 101a, and the transfer apparatus 103a may fit mechanically in place of the internal evaluation apparatus 502. The two modules, the internal evaluation apparatus 502 and the transfer apparatus 103a, may be made exchangeable for one another. In other words, the bypassing apparatus 103a may be formed as an internal evaluation apparatus, at least having the physical dimensions of the internal evaluation apparatus. In one example, the presence of the evaluation apparatus 502 may also be conveyed to the measuring instrument 101a by magnetic field or light, so as to signal that an internal evaluation apparatus 502 is present. For signaling of this type, the internal evaluation apparatus 502 may comprise a magnet or an LED and the measuring instrument may comprise a magnetic field sensor, Hall sensor and/or light sensor. To make it possible to exchange the internal evaluation apparatus for a transfer apparatus, the transfer apparatus may have the same signaling device as the evaluation apparatus, for example a magnet or an LED.

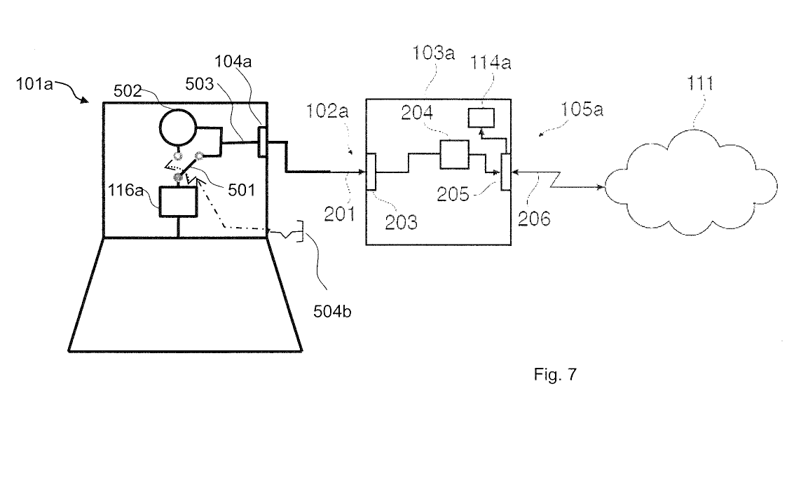

FIG. 7 is a further block diagram of a connection of a measuring instrument to a transfer apparatus comprising a switch 504b on a measuring instrument according to an exemplary embodiment of the present invention. The switch may constitute one of the embodiments previously described in the transfer apparatus 103a, for example mechanical, magnetic or optical. The switch 504 may also be realized as a pin coding, plug or socket, which react to a transfer apparatus 103a being plugged in. The switch 504b controls the bypassing device 501, in such a way that, when the transfer apparatus 103a is plugged into the measuring instrument 101a, the internal evaluation apparatus 502 is bypassed or shorted out. A switch 504b on the measuring instrument 103a may be combined with a switch 504a or pin coding 504 on the transfer apparatus 103a in any desired manner.

For completeness, it should be noted that the terms “comprising” and “having” do not exclude the possibility of other elements or steps, and the terms “a” and “one” do not exclude a plurality. It should further be noted that features or steps described with reference to one of the above embodiments may also be used in combination with other features or steps of other above-described embodiments. Reference numerals in the claims should not be treated as limiting.

1-15. (canceled)

16. A transfer apparatus for a measuring instrument, comprising:
a raw data interface configured to directly access to raw measurement data of the measuring instrument;
a labeling device labeling the raw measuring data with a measuring instrument label; and
a transmission device transmitting the labeled raw measurement data to an external evaluation apparatus,
wherein the evaluation apparatus is arranged externally to the measuring instrument and/or the transmission device,
wherein the evaluation apparatus, using the measuring instrument label, assigns the raw measurement data to the measuring instrument and/or the transfer apparatus,
wherein the raw measurement data are transmitted substantially unchanged, and
wherein the transfer apparatus is adapted to receive a calculated measurement value from the evaluation apparatus and transmit the calculated measurement value.

17. The transfer apparatus according to claim 16, wherein the raw measurement data are the measurement data of an echo curve.

18. The transfer apparatus according to claim 16, wherein the raw data interface is a measuring instrument interface selected from the group of measuring instrument interfaces consisting of an I²C interface; a HART® interface; and a 4 . . . 20 mA interface.

19. The transfer apparatus according to claim 16, wherein the raw data interface adapted to bypass an evaluation apparatus present in the measuring instrument.

20. The transfer apparatus according to claim 16, wherein the labeling device is adapted to encrypt the raw measurement data.

21. The transfer apparatus according to claim 16, wherein the transmission device comprises a transfer interface selected from the group of transmission interfaces consisting of a wired transfer interface; a radio interface; and a wide-area network interface.

22. The transfer apparatus according to claim 16, wherein the transfer apparatus is integratable into the measuring instrument.

23. A transfer apparatus for a measuring instrument, comprising:
a raw data interface configure to directly access to raw measurement data of the measuring instrument;
a labeling device labeling the raw measurement data with a measuring instrument label; and
a transmission device transmitting the labeled raw measurement data to an external evaluation apparatus,
wherein the evaluation apparatus is arranged externally to the measuring instrument and/or the transmission device,
wherein the evaluation apparatus, using the measuring instrument label, assigns the raw measurement data to the measuring instrument and/or the transfer apparatus,
wherein the raw measurement data are transmitted unchanged, and
wherein the raw data interface is configured to bypass an evaluation apparatus of the measuring instrument.

24. A method for transferring raw measurement data with a transfer apparatus, comprising:
accessing the raw measurement data of a measuring instrument using a direct access;
labeling the raw measurement data with a measuring instrument label;
transmitting the labeled raw measurement data to an external evaluation apparatus, wherein the evaluation apparatus is arranged externally to the measuring instrument and/or the transmission device, wherein the evaluation apparatus, using the measuring instrument label, assigns the raw measurement data to the measuring instrument and/or the transmission device, and wherein the raw measurement data are transmitted substantially unchanged; and
receiving a calculated measurement value from the evaluation apparatus and providing the calculated measurement value.

25. An evaluation apparatus, comprising:
a receiving device receiving raw measurement data labeled with a measuring instrument label from a transfer apparatus;
a management device managing at least one measuring instrument;
an assignment device assigning the received raw measurement data to one of the at least one managed measuring instruments;
a calculation device calculating a target measurement value from the raw measurement data; and
a provision device providing the calculated target measurement value externally on the transfer apparatus.

26. The evaluation apparatus according to claim 25, wherein the calculated measurement value is a fill level, a pressure and/or a limit.

27. The evaluation apparatus according to claim 25, wherein the calculation device is adapted to evaluate an echo curve.

28. The evaluation apparatus according to claim 25, wherein the provision device is adapted to provide the calculated target measurement value internally and/or externally.

29. A measurement system, comprising:
a measuring instrument;
a transfer apparatus according to claim 16; and
an evaluation apparatus according to claim 25,
wherein the measuring instrument is connected to the transfer apparatus via a raw data interface in such a way that the transfer apparatus can directly access the raw measurement data generated by the measuring instrument,
wherein the evaluation apparatus is connected to a communication network externally to the measuring instrument and/or the transfer apparatus, and
wherein the transfer apparatus is connected to the communication network by a transmission device, in such a way that the transfer apparatus can transmit the raw measurement data to the evaluation apparatus substantially unchanged via the communication network.

30. A program element for transferring raw measurement data which carries out a method of claim 24 for transferring raw measurement data with a transfer apparatus when executed on a processor.
